(19) United States
(12) Patent Application Publication
(10) Pub. No.: US 2026/0240064 A1
(43) Pub. Date: Aug. 20, 2026

(54) Three-Point Linkage System As Part Of An Agricultural Harvester For Stabilizing The Pendulum Movement, System And Method For Stabilizing The Pendulum Movement

(71) Applicant: PÖTTINGER Landtechnik GmbH, Grieskirchen (AT)

(72) Inventors: Andreas Dietachmair, Grieskirchen (AT); August Greifeneder, Grieskirchen (AT); Markus Reininger, Grieskirchen (AT)

(21) Appl. No.: 19/448,742

(22) Filed: Jan. 14, 2026

(30) Foreign Application Priority Data
Feb. 20, 2025 (DE) 10 2025 106 483.0

(51) Int. Cl. A01B 59/06

(52) U.S. Cl. CPC A01B 59/066

(57) ABSTRACT

A three-point linkage system for stabilizing the pendulum movement of a working assembly of a harvesting machine, such as a mowing unit and/or merger, which is coupled to the three-point linkage system, including a carrier frame which can be mounted on a tractor, an upper link, a first lower link and a second lower link. The first lower link and the second lower link are each articulated to the working assembly on the one hand and to the carrier frame on the other hand. The first lower link and the second lower link are connected to each other via a rotary cross and are mounted so as to be rotatable relative to each other about an oblique axis running from the region around the working unit-side end of the second lower link to the region around the carrier frame-side end of the first lower link by means of a rotary joint of the rotary cross.

### CROSS-REFERENCE TO RELATED APPLICATIONS

This application claims benefit under 35 USC § 119 to DE Application No. 10 2025 106 483.0 filed 20 Feb. 2025, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The invention relates to agricultural harvesters with a working assembly which is suspended in a pendulum manner for ground adaptation by means of a three-point linkage system, and in particular also to such a three-point linkage system for stabilizing the pendulum movement of a mowing unit and/or a merger of the agricultural harvester, as well as to a system consisting of the agricultural harvester and a tractor, and to a method for stabilizing the pendulum movement.

### 2. Description of Related Art

Front mount mowers are generally suspended so that they can move. The aim here is to ensure that the cutter bar can follow the ground contours in its working position close to the ground during field operation thanks to a movable suspension. On the one hand, the cutter bar should be prevented from getting stuck on the ground contour in order to prevent possible interruptions to the harvesting process or damage to the cutter bar. On the other hand, for an efficient harvesting process, the mowing unit should be guided as close as possible to the ground contour and be able to follow it easily. Similar requirements apply to mergers whose pick-up device, for example in the form of a pick-up spiked roller, should follow the ground contour light-footedly at a short distance in order to pick up the crop completely from the ground on the one hand, but on the other hand to avoid the tines piercing the ground and the associated forage contamination. To transfer the picked-up forage to the transverse conveyor, which can be a transverse conveyor belt, for example, the transverse conveyor should preferably also be able to oscillate or move so as not to generate too much offset with the pickup. Such a merger can also be combined with a mowing unit in a combination unit and follow the mowing unit.

During travel to the field or also in the headland or during turning maneuvers in the field that do not directly affect the harvesting process, however, it is not desirable for the cutter bar as part of a mowing unit or the mower unit to move too much or to oscillate back and forth.

In these situations, the mower or merging unit is therefore brought into a transport position or is being lifted out into a forward position at a sufficient distance from the ground. Here, the mowing unit should remain as stable as possible in a central position, which can, for example, be an approximately parallel position in relation to the ground contour.

Thus, for the working position and the transport position or when being lifted out into the forward position, there are opposing requirements for the mounting of the mowing unit. The suspension of the working assembly should therefore meet the requirements regarding the mounting of the mowing unit for the working position as well as for the transport position and when being lifted out into the forward position.

One possibility is to suspend the mower and/or merging unit via a pendulum axis and to implement various pendulum stabilization measures. For this purpose, tension springs, leaf springs, pressure tappets, or combined tension/compression elements can be used, which are attached to the left and/or right of the pendulum axis. The mowing unit can be brought under pretensioning, which can cause a return to the neutral or initial position in the event of deflections.

Suspending the mower via only one pendulum axis has the advantage that the measures for pendulum stabilization are easy to convert, as the mower can only be pivoted relative to the mounting frame via this one axis. This means that there is always a defined distance between a point on the mounting frame and a point on the mowing unit. This contributes to the fact that solutions for pendulum stabilization are relatively easy to implement with such a setup.

Another approach is to use a three-point linkage system for the suspension of the mowing unit. In contrast to the previously mentioned solution with only one pendulum axis, the distance between a point on the mounting frame and a point on the mowing or merging unit can change depending on the current lift height of the working assembly.

In such three-point link systems, there are various state-of-the-art approaches for stabilizing the working assembly.

One such approach involves stabilization via gravity. For this purpose, the suspension is positioned with its center above the center of gravity of the mowing unit. When the mowing unit deflects, it is restored to its original position, which is determined by the center of gravity. The disadvantage of this is that when the mowing unit is lifted out on a slope, there is no return to the center of gravity, but on the contrary a deflection occurs. Furthermore, these systems, which function purely via gravity, are disadvantageously subject to oscillation.

It was also considered to implement stabilization via spring elements in a three-point linkage system. The spring elements create a restoring force between the frame of the three-point link system and the mowing unit. The distances between the frame and the mowing unit, and therefore the spring forces, depend on the current lift height. The return springs used also have a different restoring effect depending on their position.

However, the restoring forces generated by the spring tension also influence the relief when the mower is in the working position on the ground. This is disadvantageous as the contact with the ground is reduced by the restoring forces and the ground contours can therefore be followed less precisely.

EP 3 061 337 A1 discloses a haymaking machine in the form of a merger. A movable mounting of the merger is disclosed, wherein a link arrangement is used. Furthermore, there is described a weight relief unit which is connected to the merger and the link arrangement. Furthermore, there are disclosed various spring devices.

The patent document EP 1 593 294 A1 discloses a suspension device for a mower. This describes a pivoting mounting of the mower. This is made possible by a link arrangement and various spring systems.

The patent document EP 4 252 503 A1 discloses an agricultural mower for operating in overrun mode. The mower is suspended from a frame in a pendulum manner. The mower has a linear actuator with which the mower can be locked in the center position, in particular in the raised position. This linear actuator is articulated between a linkage on the frame of the mower and a linkage on the mower deck. The linear actuator acts directly on the mower.

Furthermore, EP 4 252 503 A1 discloses that the mower is suspended via two ball joint bearings spaced apart from one another. The connecting line between the ball joint bearings forms a pivot axis about which the mower can pivot back and forth. This is not comparable with the oblique pivot axis introduced in the present invention, which is provided by the lower links and the rotary cross.

It is an object of the present invention to provide an improved harvesting machine, an improved three-point link suspension and an improved method of the type mentioned above, which avoid the disadvantages of the prior art and advantageously improve the latter. In particular, an improved pendulum stabilization of the working assembly is to be created, which avoids disadvantages with regard to the restoring effect in the working position and the dependence of the restoring effect on the lift height of the mower. At the same time, sufficient stabilization is to be achieved in the transport position and when being lifted out into the forward position.

### SUMMARY OF THE DISCLOSURE

In an exemplary embodiment of the present invention, a three-point linkage system for stabilizing the pendulum movement of a working assembly of a harvesting machine is provided, such as a mowing unit and/or merger, which is coupled to the three-point linkage system comprises a carrier frame which can be mounted on a tractor, an upper link, a first lower link and a second lower link, wherein the first lower link and the second lower link are each articulated to the working assembly on the one hand and to the carrier frame on the other hand, wherein that the first lower link and the second lower link are connected to each other via a rotary cross and are mounted so as to be rotatable relative to each other about an oblique axis running from the region around the working unit-side end of the second lower link to the region around the carrier frame-side end of the first lower link by means of a rotary joint of the rotary cross.

In another exemplary embodiment of the present invention, an agricultural harvester is provided that includes the inventive a three-point linkage system and a working assembly connected thereto, such as a mowing unit and/or a merger.

In another exemplary embodiment of the present invention, a system comprising a tractor and an innovative agricultural harvester is provided, wherein the three-point linkage system connects the working assembly to the tractor.

In another exemplary embodiment of the present invention, a method for stabilizing the pendulum movement of a harvesting unit of a harvesting machine is provided, in particular a mowing unit and/or a merger, which is coupled to a tractor via the innovative three-point linkage system, wherein the harvesting assembly is suspended in a pendulum manner in the working position in order to follow the ground contours, wherein the working assembly is held in an initial position when the tractor performs a cornering movement and/or the working assembly is lifted out into a headland position and/or transport position.

In another exemplary embodiment, the present invention comprises a three-point linkage system for stabilizing the pendulum movement of a mowing unit and/or a merging unit during deflection, which is coupled to the three-point linkage system. The three-point linkage system comprises a carrier frame, an upper link, a first lower link and a second lower link, the first lower link and the second lower link being articulated to the mowing unit and/or merging unit on the one hand and to the carrier frame on the other. The first lower link and the second lower link are connected to one another via a rotary cross, the two lower links being rotatable relative to one another about an oblique axis running from the region around the end of the second lower link, which is connected to the mowing unit and/or merger, to the region around the end of the first lower link, which is facing away from the mowing unit and/or merger, by means of the rotary cross forming a rotary joint.

Preferably, an actuator can act on the rotary cross, which can exert a torque with respect to the rotary joint, which can act on the two lower links via the two halves of the rotary cross, so that the mowing unit can be restored to an initial position after deflection via the first and second lower links.

In particular, the initial position to which the mowing unit and/or the merger can be restored can be an orientation of the mowing unit and/or the merger, which can be at least approximately at right angles to the z-axis of the three-point linkage system. In this case, the z-axis can be an upright axis, which can be approximately perpendicular to the ground contact surface on which, for example, a tractor to which the harvesting machine can be attached stands. The z-axis is approximately vertical when the contact surface is horizontal, but can also be inclined relative to the vertical when the contact surface is sloping and/or inclined at an angle.

In an advantageous further development of the invention, the actuator can be controlled in a targeted manner via a control unit such that the mowing unit and/or the merger can be brought back into the initial position when the mowing unit and/or the merger is exposed to a curved movement and/or is in the lifted out into the forward position and/or transport position, which can be detected, for example, by one or more sensor systems or a suitable detection device and/or can be determined by a steering signal of the tractor and/or a lift-out signal.

For example, the actuator can comprise a torque rod spring and/or a tension spring and/or a compression spring and/or an actuator cylinder.

In an advantageous embodiment of the invention, the actuator cylinder can comprise a pressure medium, for example a hydraulic cylinder. In an alternative embodiment, this can also be a pneumatic cylinder.

In particular, the pressure medium cylinder can be connected to a pressure medium accumulator so that the cylinder can act like an extendable spring.

Alternatively or additionally, the actuator can also comprise a rotary pressure actuator, e.g., in the form of a hydraulic motor. Alternatively or additionally, an electric actuator, e.g., in the form of an electric motorized adjusting spindle, can also be provided.

In an advantageous further development of the invention, the pressure medium cylinder or actuator can be coupled to a lift-out actuator in such a manner that pressurizing of the pressure medium cylinder can take place when pressure is applied to the lift-out actuator.

In an advantageous embodiment of the invention, the return actuator can be controlled actively depending on the contact pressure or running resistance determined.

Preferably, the actuator can be actively controlled by means of position monitoring in order to distribute the load evenly across the entire working width of the mowing unit and/or the merger.

In an advantageous further development of the invention, the carrier frame and/or the lower links can be provided with rubber buffers so that the carrier frame and/or the lower links can abut against the rubber buffers in an end position and/or transport position.

In another exemplary embodiment, the present invention comprises a three-point linkage system configured to stabilize a pendulum movement of a working unit comprising a carrier frame, an upper link, a first lower link having a carrier frame-side end in proximity to the carrier frame, and a second lower link having a working unit-side end in proximity to the working unit, wherein each of the first lower link and the second lower link is articulated between the working unit and the carrier frame, the first lower link and the second lower link are connected via a rotary cross, and the first lower link and the second lower link are mounted so as to be rotatable relative to each other about an oblique axis running from a region around the working unit-side end of the second lower link to a region around the carrier frame-side end of the first lower link by means of a rotary joint of the rotary cross.

In any of the exemplary embodiments, the working unit can be moveable between working unit positions, the rotary cross can comprise a return actuator connected to two portions of the rotary cross and provided for generating a torque with respect to the rotary joint of the rotary cross, and the torque acts on the first and second lower links via the two portions of the rotary cross so that a return of the working unit to an initial position of the working unit positions takes place after a deflection via the first and second lower links.

In any of the exemplary embodiments, the carrier frame and/or the first and second lower links can be provided with damper stops and/or damper elements so that the carrier frame and/or the first and second lower links abut against the damper stops and/or damper elements in one or more of an end position of the working unit positions or a transport position of the working unit positions.

In any of the exemplary embodiments, the initial position of the working unit is an orientation of the working unit in, or tangentially to, a plane that is at least approximately perpendicular to a z-axis of the three-point linkage system, and the z-axis of the three-point linkage system is an upright axis approximately perpendicular to a ground contact surface.

In any of the exemplary embodiments, the return actuator can be controllable via a control unit in such a manner that the working unit is returned to the initial position when the working unit is exposed to a curved movement and/or is lifted out into one or more of a headland position of the working unit positions or a transport position of the working unit positions.

In any of the exemplary embodiments, the return actuator can comprise a spring selected from a group consisting of a torque rod spring, a tension spring, and a compression spring.

In any of the exemplary embodiments, the return actuator can comprise an actuator cylinder.

In any of the exemplary embodiments, the return actuator can comprise an electric actuator.

In any of the exemplary embodiments, the return actuator can be configured to be actively controlled depending on a contact pressure or a running resistance.

In any of the exemplary embodiments, the return actuator can be configured to be actively controlled by means of position monitoring in order to distribute a load evenly over a working width of the working unit.

In any of the exemplary embodiments, the actuator cylinder can be a hydraulic cylinder, and the hydraulic cylinder can be connected to a pressure medium accumulator for pressurizing and/or pretensioning the hydraulic cylinder.

In any of the exemplary embodiments, the actuator cylinder can be coupled to a lift-out actuator such that pressurizing of the actuator cylinder to return the working unit to the initial position takes place when pressure is applied to the lift-out actuator to lift out the working unit.

In another exemplary embodiment, the present invention comprises a three-point linkage system configured to stabilize a pendulum movement of a working unit of a harvesting machine that is coupled to the three-point linkage system, the system comprising a carrier frame that can be mounted on a tractor, an upper link, a first lower link, and a second lower link, wherein the first lower link and the second lower link are each articulated to the working unit on the one hand and to the carrier frame on the other hand, the first lower link and the second lower link are connected to each other via a rotary cross, the first lower link and the second lower link are mounted so as to be rotatable relative to each other about an oblique axis running from a region around a working unit-side end of the second lower link to a region around a carrier frame-side end of the first lower link by means of a rotary joint of the rotary cross, and the rotary cross comprises a return actuator that is connected to two portions of the rotary cross and is provided for generating a torque with respect to the rotary joint, which torque acts on the first and second lower links via the two portions of the rotary cross, so that a restoring of the working unit to an initial position takes place after a deflection via the first and second lower links.

A method according to the invention comprises, as already expressed, the stabilization of the pendulum movement of a mowing unit and/or a merger, which are coupled to a tractor via the three-point linkage system. The mowing unit is suspended so that it can oscillate in the working position in order to follow the ground contours during mowing operation. The mowing unit and/or the merger are held in an initial position when the tractor is cornering and/or the mowing unit is held in the lifted out into the forward position and/or a transport position is assumed.

According to the present invention, it is provided that the deflections of the mowing unit and/or the merger in mowing mode can act on the rotary cross with the rotary joint via the first and/or second lower link, wherein the pendulum movement can be stabilized by the rotary cross with the actuator.

Preferably, in the end position and/or transport position, the carrier frame and/or the lower links can be brought into contact with, preferably, damping stops or damper pads or damper elements, such as rubber buffers, which can be attached to the carrier frame and/or the lower links.

In another exemplary embodiment, the present invention is a method comprising stabilizing a pendulum movement of a harvesting unit of a harvesting machine that is coupled to a tractor via the three-point linkage system according to any of the exemplary embodiments, wherein the harvesting unit is suspended in a pendulum manner in a working position in order to follow ground contours, and at least one of the harvesting unit is held in an initial position when the tractor performs a cornering movement, or the harvesting unit is lifted out into a headland position and/or transport position.

In any of the exemplary embodiments, the pendulum deflections of the harvesting unit in a working operation via the first and/or second lower links can be converted via the rotary cross into rotary movements of the rotary joint by stabilizing the rotary cross by means of a return actuator.

In another exemplary embodiment, the present invention is a method comprising suspending a harvesting unit of a harvesting machine in a working position in order to follow ground contours, the harvesting machine coupled to a tractor, stabilizing a pendulum movement of the harvesting unit via the three-point linkage system according to any of the exemplary embodiments, and at least one of holding the harvesting unit in an initial position when the tractor performs a cornering movement, or lifting the harvesting unit out into a headland position and/or transport position.

In any of the exemplary embodiments, the method can further comprise stabilizing the rotary cross by means of a return actuator, and converting pendulum deflections of the harvesting unit in a working operation via the first and/or second lower links via the rotary cross into rotary movements of the rotary joint by the stabilizing.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features can also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 illustrates a system comprising a tractor, a three-point linkage system and a mowing unit according to an exemplary embodiment of the present invention.

FIG. 2 illustrates a three-point linkage system with lower links and a rotary cross and a cross member of the mowing unit according to an exemplary embodiment of the present invention.

FIG. 3 illustrations a lower link connected to a rotary cross equipped with an hydraulic cylinder according to an exemplary embodiment of the present invention.

FIGS. 4A-4B are illustrations of the system with various positions of the cutter bar in working position with ground support according to an exemplary embodiment of the present invention. FIG. 4A: straight orientation of the cutter bar; and FIG. 4B: lateral deflection of the cutter bar.

FIG. 5 is a detailed view of a three-point link system with a cross member of a mowing unit in a working position with ground support in lateral deflection according to an exemplary embodiment of the present invention.

FIG. 6 illustrates a lower link connected to a rotary cross in lateral deflection according to an exemplary embodiment of the present invention.

FIGS. 7A-7B illustrate a system with a stabilized mowing unit in the lifting process according to an exemplary embodiment of the present invention. FIG. 7A: general view; and FIG. 7B: section with detailed side view of the three-point linkage system with mowing unit.

FIGS. 8A-8B illustrate a system with a mowing unit in a transport position according to an exemplary embodiment of the present invention. FIG. 8A: General view; and FIG. 8B: Section with detailed side view of the three-point link system with rubber buffers with mowing unit.

FIG. 9 is a detailed section of a system with a sideways rotated representation of a three-point link system with rubber buffers and a mowing unit according to an exemplary embodiment of the present invention.

FIGS. 10A-10B illustrate a three-point linkage system with a cross member of a mowing unit and an hydraulic cylinder with hydraulic accumulator according to an exemplary embodiment of the present invention. FIG. 10A: overall view; and FIG. 10B: detailed section of rotary cross with hydraulic cylinder and hydraulic accumulator in lateral deflection.

FIGS. 11A-11B illustrate a three-point linkage system with a cross member of a mowing unit and a torque rod spring according to an exemplary embodiment of the present invention. FIG. 11A: overall view; and FIG. 11B: detailed section of rotary cross with torque rod spring in lateral deflection.

FIGS. 12A-12B illustrate a three-point linkage system with a cross member of a mowing unit and a tension spring and/or a compression spring according to an exemplary embodiment of the present invention. FIG. 12A: overall view; and FIG. 12B: detailed section of rotary cross with tension spring and/or a compression spring in lateral deflection.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

As used herein, the term “about” or “approximately” means, for example, within 10%, within 5%, or less. In some embodiments, the term “about” can mean within measurement error. In this regard, when described or claimed, all numerical values may be read as if preceded by the word “about” or “approximately,” even if the term is not explicitly stated. The phrase “about” or “approximately,” when describing a size and/or location, may be used to indicate that the stated value and/or location is within a reasonable expected range of value and/or location. For example, a numerical value may include values that are ±0.1% of the stated value (or range of values), ±1% of the stated value (or range of values), ±2% of the stated value (or range of values), ±5% of the stated value (or range of values), ±10% of the stated value (or range of values), etc. As described herein, all numerical ranges are intended to include the endpoints and all subranges therein, unless specifically stated otherwise.

As used herein, the term “substantially” means allowing for deviations from a descriptor that do not adversely affect the intended purpose. For example, deviations resulting from measurement limitations, differences within manufacturing tolerances, or variations of less than 5% can be considered to be within substantially the same range. The specified descriptors can be absolute (e.g., substantially spherical, substantially perpendicular, substantially concentric, etc.) or relative (e.g., substantially similar, substantially the same, etc.).

Similarly, as used herein, “substantially free” of something, or “substantially pure,” and like characterizations, can include both being “at least substantially free” of something, or “at least substantially pure,” and being “completely free” of something, or “completely pure.”

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

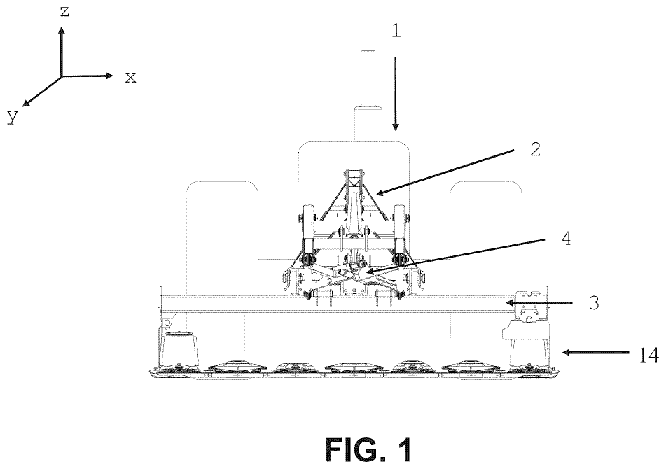

FIG. 1 shows the tractor 1, the three-point linkage system 2 and the working assembly 14, which can be configured in the form of a mowing unit and/or a merger.

The mowing or working unit 14 can have a cross member 3, which carries the working or mowing tools such as mowing discs or drums. The three-point linkage system 2 can be articulated to this cross member 3. The three-point linkage system 2 forms an articulated suspension of the working assembly and part of the connection between the working assembly 14 and the tractor 1.

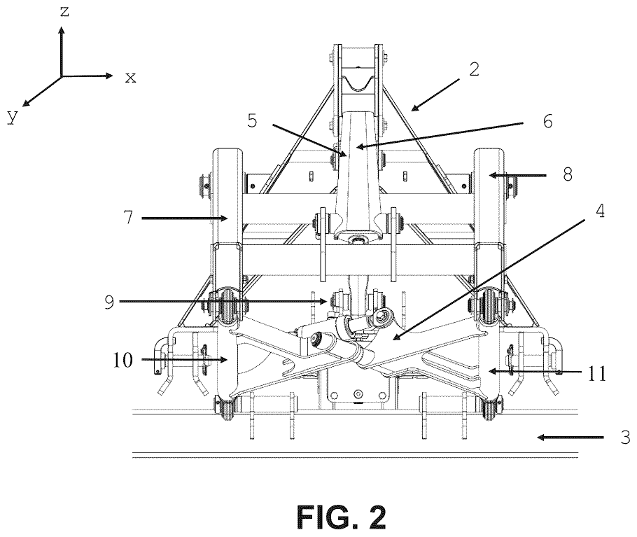

FIG. 2 shows the three-point linkage system 2 with the lower links 10, 11 and the rotary cross 4 and the cross member 3 of the mowing unit 14. The three-point linkage system 2 has a link arrangement. A first link 7 and a second link 8 form a carrier frame.

The carrier frame 7, 8 can be connected to a lifting arm 5 via a cross strut. The lifting arm 5 can be connected to a lift-out actuator 6. The lift-out actuator 6 can thus act on the carrier frame 7, 8 and cause the carrier frame 7, 8 to adjust its position. The carrier frame 7, 8 can be lowered forwards or raised backwards in the direction of travel.

The first and second lower links 10, 11 are connected to the carrier frame 7, 8. The lower links 10, 11 are pivotably hinged to the carrier frame 7, 8. Furthermore, the lower links 10, 11 are pivotably articulated to the cross member 3 of the mowing unit 14. The articulated connection can be, for example, a ball joint.

The lifting arm 5 can also be connected to the upper link 9, which can also be pivotably connected to the mowing unit. The first lower link 10 and the second lower link 11 are connected to each other via a rotary cross 4.

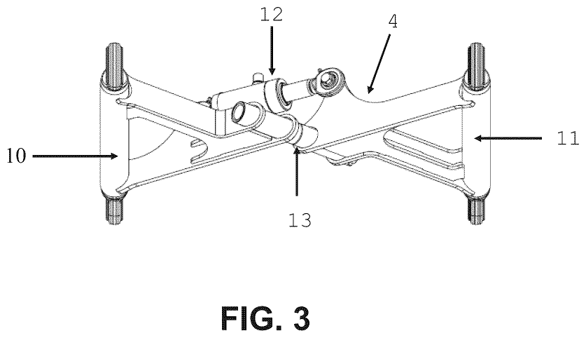

FIG. 3 shows the lower links 10, 11 and their connection via the rotary cross 4. The lower links 10, 11 are mounted for rotation about an oblique axis, running from the region around the end of the second lower link 11, which is connected to the mowing unit 14, to the region around the end of the first lower link 10, which is facing away from the mowing unit, by means of a rotary joint 13. See FIG. 2 for the connection of the lower links 10, 11 to the mowing unit 14 or the cross member 3.

The described oblique axis can alternatively extend from the region around the end of the first lower link 10, which is connected to the mowing unit 14, to the region around the end of the second lower link 11, which is facing away from the mowing unit 14. The rotatable mounting of the lower links 10, 11 by means of a rotary joint 13 can also be implemented. See FIG. 2 for the connection of the lower links 10, 11 to the mowing unit 14 or the cross member 3.

The rotary cross 4 can, for example, comprise two V-shaped halves that are connected at their tapered ends by the rotary joint 13.

The rotary cross 4 can comprise a return actuator, which can be connected to the halves of the rotary cross at a distance from the rotary joint 13 and can be provided for generating a torque, which can act on the two lower links 10, 11 via the two halves of the rotary cross 4, so that the mowing unit 14 can be restored to an initial position after a deflection via the first and second lower links 10, 11.

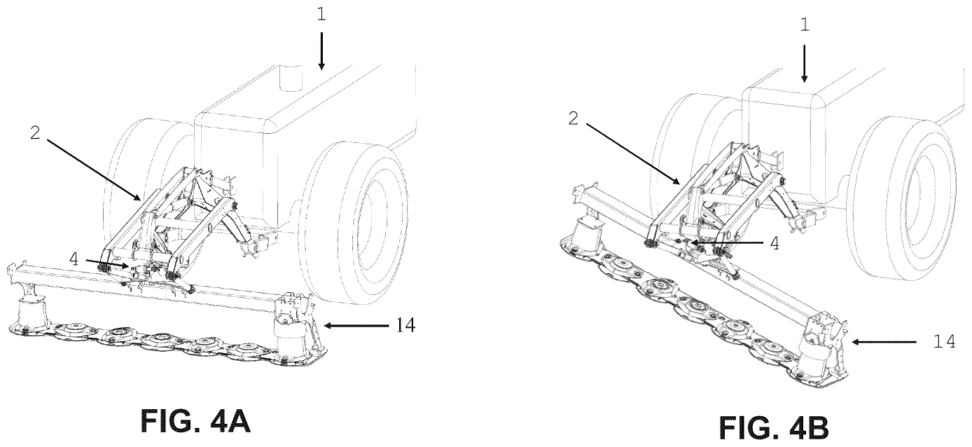

FIG. 4 shows a representation of the system with various positions of the cutter bar or mowing unit 14 in the working position with ground support. FIG. 4A shows an approximately parallel orientation of the mowing unit 14 to the ground or substrate. FIG. 4B shows a lateral deflection of the mowing unit 14.

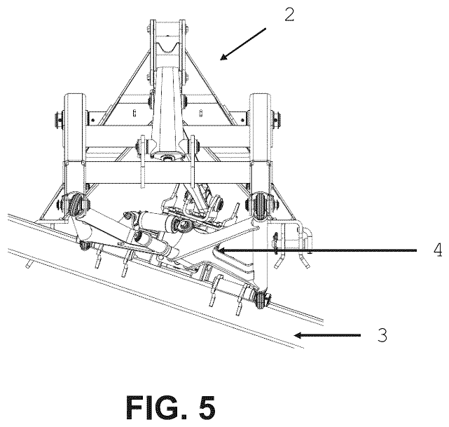

FIG. 5 shows a detailed view of the three-point link system 2 with the lower links 10, 11 in conjunction with the cross member 3 of the mowing unit 14 in the working position with ground support in lateral deflection.

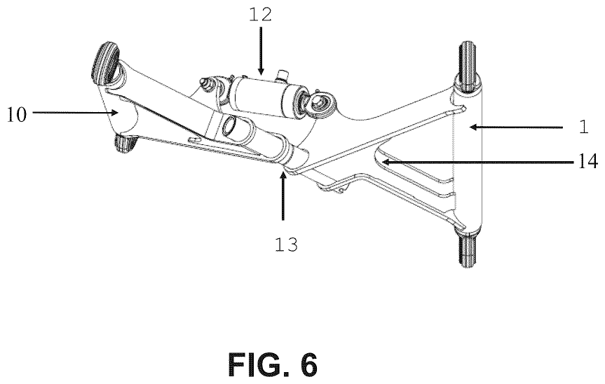

FIG. 6 shows a detailed representation of the lower links 10, 11 with the rotary cross 4 in lateral deflection as an example of the case of an oblique deflection in the working position of the mowing unit 14. The actuator acting on the rotary cross can comprise a hydraulic cylinder.

The hydraulic cylinder, which can be connected to the halves of the rotary cross at the side of the rotary joint 13 and can be provided for generating a torque which can act on the two lower links 10, 11 via the two halves of the rotary cross 4, so that the mowing unit 14 can be restored to an initial position after deflection via the first and second lower links 10, 11.

Thus, the mowing unit 14 can be brought from an obliquely deflected position, as shown in FIG. 4B, back to an initial position, as shown in FIG. 4A, by the action of the actuator 12.

The initial position to which the mowing unit 14 can be restored can be an orientation of the mowing unit 14 at least approximately perpendicular to the z-axis of the three-point linkage system 2, wherein the z-axis can be an upright axis approximately perpendicular to the ground contact surface.

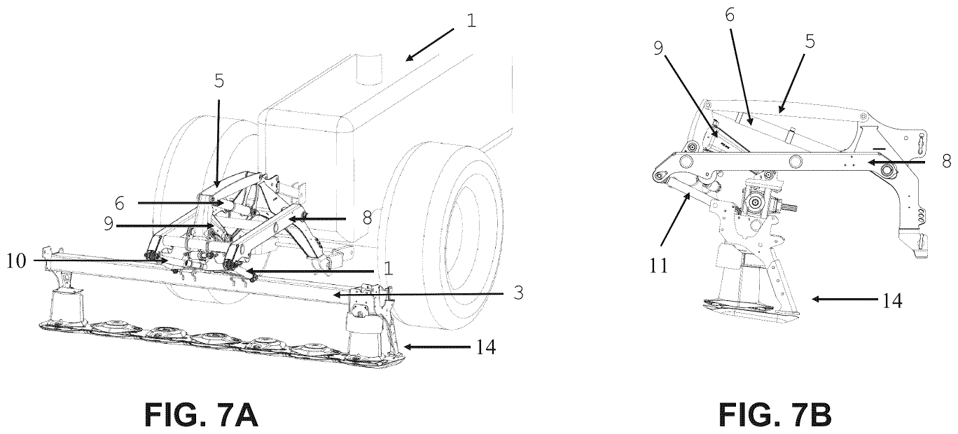

FIG. 7A shows the system with stabilized mowing unit 14 in the lifting process. The mowing unit 14 is thus in an intermediate position during the transition from the working position to the transport position.

FIG. 7B shows a detailed side view of the mowing unit 14 and the three-point linkage system 2.

The actuator can be controlled via a control unit in such a manner that the mowing unit 14 is returned to the initial position when the mowing unit 14 is exposed to curved movement and/or when being lifted out into the forward position and/or transport position.

Thus, the mowing unit 14 can be actively stabilized and held in a desired position.

Advantageously, the actuator can be controlled actively depending on the determined contact pressure or running resistance.

The actuator can, for example, be actively controlled by means of position monitoring in order to distribute the load or contact pressure evenly over the entire working width of the mowing unit. The position monitoring can detect the position and/or the contact pressure of several portions of the working assembly, e.g., distributed across the width of the assembly beam, by sensor system or otherwise determine it, e.g., estimate it.

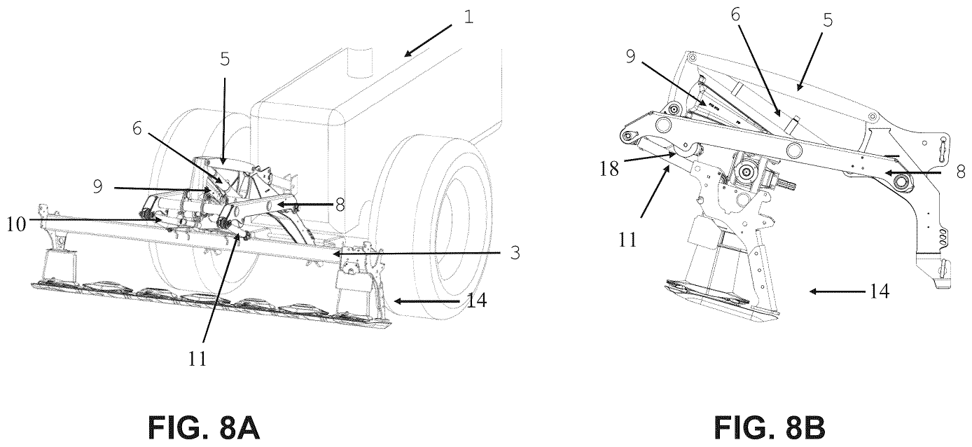

FIG. 8A shows the system with the mowing unit 14 in the transport position. FIG. 8B shows a section with a detailed side view of the three-point link system 2 with mowing unit 14 and with rubber buffers 18.

The carrier frame 7, 8 and/or the lower links 10, 11 can be provided with rubber buffers 18 or similar damping elements or stops, so that the carrier frame 7, 8 and/or the lower links 10, 11 can abut against the rubber buffers 18 in an end position and/or transport position.

The lower links 10, 11 can be fixed with the rubber buffers 18.

By using the rubber buffers 18 there can take place an additional stabilization of the mowing unit 14 in the transport position.

In the transport position, the mowing unit 14 can be in a slightly tilted position from the direction of travel.

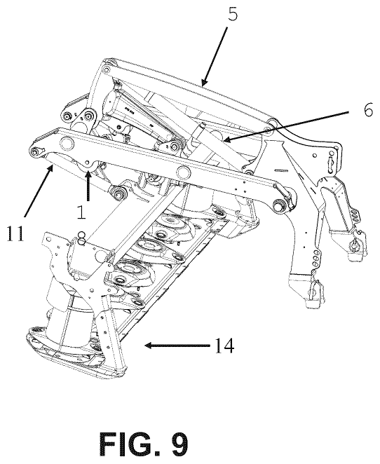

FIG. 9 shows a detailed section of the system with a laterally rotated view of the three-point link system 2 with the mowing unit 14 and with the rubber buffers 18.

The mowing unit can be stabilized in the transport position by the rubber buffers, in particular in such a manner that the lower links 10, 11 can not only abut against the rubber buffers, but can also slide along the inside of the rubber buffers 18 due to their laterally offset positioning. In this manner, the rubber buffers 18 can overlap the lower links 10, 11 on their outer side and in this way buffer lateral deflection movements of the mowing unit 14.

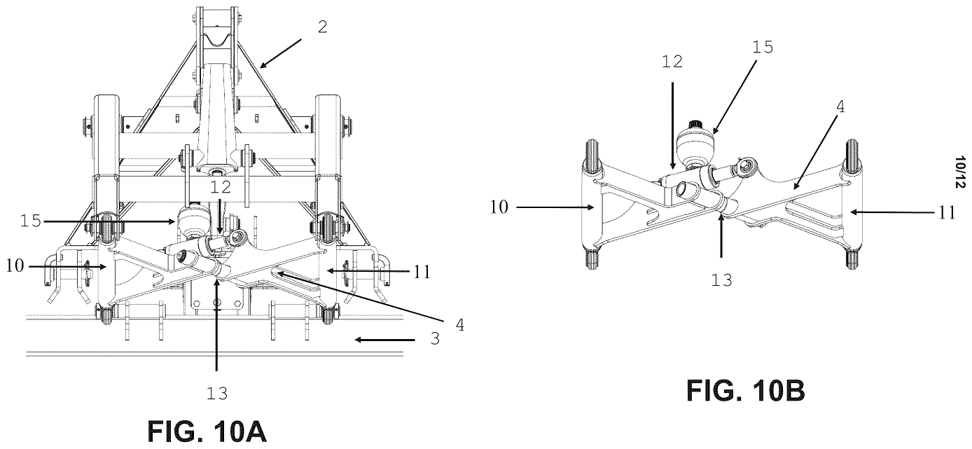

FIG. 10A shows the three-point linkage system 2 with cross member 3 and a hydraulic cylinder 12 with a hydraulic accumulator 15. FIG. 10B shows a detailed section of the rotary cross 4 with a hydraulic cylinder 12 and a hydraulic accumulator 15.

Alternatively, the hydraulic cylinder 12 can be coupled to the lift-out actuator 6 in such a manner that pressurizing of the hydraulic cylinder 12 takes place when the lift-out actuator 6 is pressurized. For this purpose, a pressure sequence valve can be mounted between the lift-out actuator 6 and the hydraulic cylinder 12 so that the pressure level in the hydraulic cylinder 12 can be increased in the sequence control. This allows the mower 12 to oscillate or float in the working position and thus follow the ground contours in its movements. In the headland position and/or transport position, however, the hydraulic cylinder 12 can also be pressurized by actuating the lift-out actuator 6 and thus ensure stabilization of the mowing unit.

As a result, there is no influence from any restoring forces on the mowing unit 14. The mowing unit 14 is thus completely relieved, in contrast to the use of spring systems. Furthermore, the stabilization of the mowing unit by the hydraulic cylinder 12 is not dependent on the lift height.

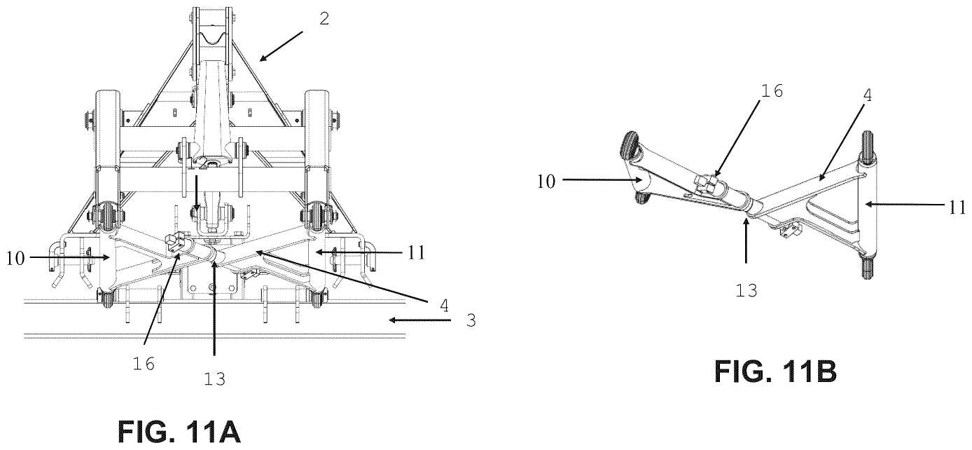

FIG. 11A shows a three-point linkage system 2 with cross member 3 and torque rod spring 16. FIG. 11B shows a detailed section of the rotary cross 4 with torque rod spring 16 in lateral deflection.

The actuator can comprise a torque rod spring 16. The torque rod spring 16 can exert a pretensioning effect on the rotatably mounted halves of the rotary cross 4. This can stabilize the pendulum movement of the mowing unit 14.

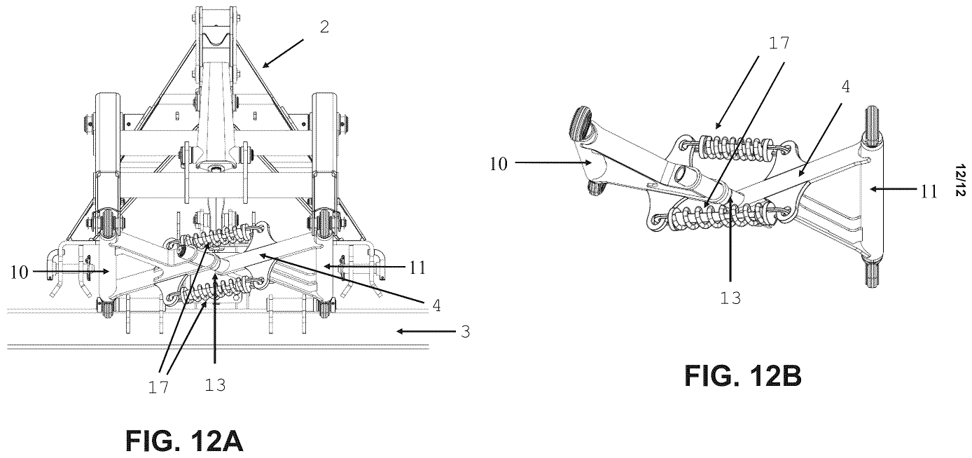

FIG. 12A shows a three-point linkage system 2 with cross member 3 and tension spring and/or a compression spring 17. FIG. 12B shows a detailed section of the rotary cross 4 with tension spring and/or a compression spring 17 in lateral deflection.

The actuator can comprise a tension spring and/or a compression spring 17. The tension spring and/or a compression spring 17 can exert a pretensioning effect on the rotatably mounted halves of the rotary cross 4. This can stabilize the pendulum movement of the mowing unit 14.

For stabilizing the pendulum movement of a mowing unit and/or a merger 14 there is used a method which uses the three-point linkage system 2 according to one of the claims 1 to 14.

The mowing unit 14, which is coupled to the tractor 1 via the three-point linkage system 2 is suspended in an oscillating manner in the working position in order to follow the ground contours during mowing operation, wherein the mowing unit and/or the merger 14 is held in an initial position when the tractor is cornering and/or the mowing unit 14 is held in a lifted out into the forward position and/or a transport position is assumed.

During mowing operation, the deflections of the mowing unit and/or the merger 14 can act on the rotary cross 4 with the rotary joint 13 via the first and/or second lower links 10, 11, wherein the pendulum movement can be stabilized by the rotary cross 4 with the actuator. This is shown in FIG. 4A and FIG. 4B. FIG. 4A shows the working position of the cutter bar of the mowing unit 14 in parallel orientation to the ground and FIG. 4B shows a lateral deflection of the cutter bar of the mowing unit 14.

The mowing unit 14 is stabilized in an initial position when the tractor 1 is cornering and/or the mowing unit 14 is held in the lifted out into the forward position and/or a transport position is assumed.

This initial position, in which the mowing unit and/or the merger 14 is held, can be an orientation at least approximately at right angles to the z-axis of the three-point linkage system 2, wherein the z-axis can be an upright axis approximately perpendicular to the ground contact surface.

Lifting out into the forward position can be associated with lifting the mowing unit 14 in the z-direction, as shown in FIG. 7A and the FIG. 7B. The mowing unit 14 can thus be in a lifting process. The lifting process can be initiated by the lift-out actuator 6.

The transport position is shown in FIG. 8A and FIG. 8B. In this respect, it can be seen that the carrier frame 7, 8 and/or the lower links 10, 11 can be brought into contact with the rubber buffers 18 in the end position and/or transport position, which can be attached to the carrier frame 7, 8 and/or the lower links 10, 11.

The mowing unit and/or the merger 14 can be brought back into the initial position from a laterally deflected position by the actuator acting on the rotary cross 4. FIG. 6 shows the rotary cross 4, which in this case is provided with a hydraulic cylinder 12 as an actuator, in a laterally deflected position. FIG. 3, on the other hand, shows the rotary cross 4 with the actuator back in the initial position.

### LIST OF REFERENCE SIGNS

1 Tractor;
2 Three-Point Linkage System;
3 Cross Member;
4 Rotary Cross;
5 Lifting Arm;
6 Lift-Out Actuator;
7 Carrier Frame (First Link);
8 Carrier Frame (Second Link);
9 Upper Link;
10 First Lower Link;
11 Second Lower Link;
12 Hydraulic Cylinder;
13 Rotary Joint;
14 Mowing Unit;
15 Hydraulic Accumulator;
16 Torque Rod Spring;
17 Spring; and
18 Rubber Buffer.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

What is claimed is:

1. A three-point linkage system configured to stabilize a pendulum movement of a working unit comprising:
a carrier frame;
an upper link;
a first lower link having a carrier frame-side end in proximity to the carrier frame; and
a second lower link having a working unit-side end in proximity to the working unit;
wherein:
each of the first lower link and the second lower link is articulated between the working unit and the carrier frame;
the first lower link and the second lower link are connected via a rotary cross; and
the first lower link and the second lower link are mounted so as to be rotatable relative to each other about an oblique axis running from a region around the working unit-side end of the second lower link to a region around the carrier frame-side end of the first lower link by means of a rotary joint of the rotary cross.

2. The three-point linkage system according to claim 1, wherein:
the working unit is moveable between working unit positions;
the rotary cross comprises a return actuator connected to two portions of the rotary cross and provided for generating a torque with respect to the rotary joint of the rotary cross; and
the torque acts on the first and second lower links via the two portions of the rotary cross so that a return of the working unit to an initial position of the working unit positions takes place after a deflection via the first and second lower links.

3. The three-point linkage system according to claim 1, wherein the carrier frame and/or the first and second lower links are provided with damper stops and/or damper elements so that the carrier frame and/or the first and second lower links abut against the damper stops and/or damper elements in one or more of an end position of the working unit positions or a transport position of the working unit positions.

4. The three-point linkage system according to claim 2, wherein:
the initial position of the working unit is an orientation of the working unit in, or tangentially to, a plane that is at least approximately perpendicular to a z-axis of the three-point linkage system; and
the z-axis of the three-point linkage system is an upright axis approximately perpendicular to a ground contact surface.

5. The three-point linkage system according to claim 2, wherein the return actuator is controllable via a control unit in such a manner that the working unit is returned to the initial position when the working unit is exposed to a curved movement and/or is lifted out into one or more of a headland position of the working unit positions or a transport position of the working unit positions.

6. The three-point linkage system according to claim 2, wherein the return actuator comprises a spring selected from a group consisting of a torque rod spring, a tension spring, and a compression spring.

7. The three-point linkage system according to claim 2, wherein the return actuator comprises an actuator cylinder.

8. The three-point linkage system according to claim 2, wherein the return actuator comprises an electric actuator.

9. The three-point linkage system according to claim 2, wherein the return actuator is configured to be actively controlled depending on a contact pressure or a running resistance.

10. The three-point linkage system according to claim 2, wherein the return actuator is configured to be actively controlled by means of position monitoring in order to distribute a load evenly over a working width of the working unit.

11. The three-point linkage system according to claim 7, wherein:
the actuator cylinder is a hydraulic cylinder; and
the hydraulic cylinder is connected to a pressure medium accumulator for pressurizing and/or pretensioning the hydraulic cylinder.

12. The three-point linkage system according to claim 7, wherein the actuator cylinder is coupled to a lift-out actuator such that pressurizing of the actuator cylinder to return the working unit to the initial position takes place when pressure is applied to the lift-out actuator to lift out the working unit.

13. An agricultural harvester comprising:
the three-point linkage system according to claim 1; and
a working unit.

14. A system comprising:
the agricultural harvester according to claim 13; and
a tractor;
wherein the three-point linkage system connects the working unit to the tractor.

15. A three-point linkage system configured to stabilize a pendulum movement of a working unit of a harvesting machine that is coupled to the three-point linkage system, the system comprising:
a carrier frame that can be mounted on a tractor;
an upper link;
a first lower link; and
a second lower link;
wherein:
the first lower link and the second lower link are each articulated to the working unit on the one hand and to the carrier frame on the other hand;
the first lower link and the second lower link are connected to each other via a rotary cross;
the first lower link and the second lower link are mounted so as to be rotatable relative to each other about an oblique axis running from a region around a working unit-side end of the second lower link to a region around a carrier frame-side end of the first lower link by means of a rotary joint of the rotary cross; and
the rotary cross comprises a return actuator that is connected to two portions of the rotary cross and is provided for generating a torque with respect to the rotary joint, which torque acts on the first and second lower links via the two portions of the rotary cross, so that a restoring of the working unit to an initial position takes place after a deflection via the first and second lower links.

16. The three-point linkage system according to claim 15, wherein at least one of:
the return actuator comprises an actuator cylinder operating with a pressure medium, the actuator cylinder coupled to a lift-out actuator such that pressurizing of the actuator cylinder to restore the working unit to the initial position takes place when pressure is applied to the lift-out actuator to lift out the working unit;
the return actuator comprises an electric actuator;
the return actuator is actively controlled depending on a determined contact pressure or running resistance;
the return actuator is actively controlled by means of position monitoring in order to distribute a load evenly over a working width of the working unit; or
one or more of the carrier frame or the first and second lower links are provided with one or more of damper stops or damper elements, so that the one or more of the carrier frame or the first and second lower links abut against the one or more of damper stops or damper elements in an end position and/or transport position of the working unit.

17. A method comprising:
stabilizing a pendulum movement of a harvesting unit of a harvesting machine that is coupled to a tractor via the three-point linkage system according to claim 1;
wherein:
the harvesting unit is suspended in a pendulum manner in a working position in order to follow ground contours; and
at least one of:
the harvesting unit is held in an initial position when the tractor performs a cornering movement; or
the harvesting unit is lifted out into a headland position and/or transport position.

18. The method according to claim 17, wherein pendulum deflections of the harvesting unit in a working operation via the first and/or second lower links are converted via the rotary cross into rotary movements of the rotary joint by stabilizing the rotary cross by means of a return actuator.

19. A method comprising:
suspending a harvesting unit of a harvesting machine in a working position in order to follow ground contours, the harvesting machine coupled to a tractor;
stabilizing a pendulum movement of the harvesting unit via the three-point linkage system according to claim 1; and
at least one of:
holding the harvesting unit in an initial position when the tractor performs a cornering movement; or
lifting the harvesting unit out into a headland position and/or transport position.

20. The method according to claim 19 further comprising:
stabilizing the rotary cross by means of a return actuator; and
converting pendulum deflections of the harvesting unit in a working operation via the first and/or second lower links via the rotary cross into rotary movements of the rotary joint by the stabilizing.
